(19) United States
(12) Patent Application Publication
(10) Pub. No.: US 2021/0279854 A1
(43) Pub. Date: Sep. 9, 2021

(54) INSPECTION TERMINAL DEVICE, INSPECTION DEVICE, INSPECTION SYSTEM, AND INSPECTION PROGRAM

(71) Applicant: KABUSHIKI KAISHA TOSHIBA, Tokyo (JP)

(72) Inventors: Yasutomo SHIOMI, Koza (JP); Yusuke HIROSE, Yokohama (JP); Taisuke WASHITANI, Yokohama (JP); Takahiro MANABE, Yokohama (JP); Kohsuke TAKAI, Kawasaki (JP)

(73) Assignee: KABUSHIKI KAISHA TOSHIBA, Tokyo (JP)

(21) Appl. No.: 17/169,760

(22) Filed: Feb. 8, 2021

(30) Foreign Application Priority Data
Mar. 6, 2020 (JP) 2020-038484

(51) Int. Cl. G06T 7/00; G06K 9/46; H04N 7/18; G06T 7/70

(52) U.S. Cl. CPC G06T 7/0004; G06K 9/4604; G06T 2207/30108; G06T 7/70; H04N 7/18

(57) ABSTRACT

An inspection terminal device includes an imager, a displayer, a feature extractor, and an evaluator. The imager images an inspection object. The displayer displays an image of the inspection object imaged by the imager. The feature extractor extracts a feature of the inspection object in the image. The evaluator evaluates the inspection object based on the feature. The displayer displays an evaluation result of the evaluator to correspond to a position of the inspection object in the image.

### CROSS-REFERENCE TO RELATED APPLICATIONS

This application is based upon and claims the benefit of priority from the prior Japanese Patent Application No. 2020-038484, filed on Mar. 6, 2020; the entire contents of which are incorporated herein by reference.

### FIELD

Embodiments relate to an inspection terminal device, an inspection device, an inspection system, and an inspection program.

### BACKGROUND

For example, it is desirable to detect the appropriateness of the connection state of an inspection object automatically and with high accuracy for inspection objects such as many crimping terminals connected to a distribution board or the like, a temperature sensor connected to a socket, etc.

### BRIEF DESCRIPTION OF THE DRAWINGS

FIG. 1 is a schematic view illustrating a configuration of an inspection system according to a first embodiment;

FIGS. 2A to 3B are diagrams showing an example of a display screen of a displayer of an inspection terminal device according to the first embodiment;

FIGS. 4A to 4C are diagrams showing examples of feature extraction of an inspection device according to the inspection system according to the first embodiment;

FIGS. 5A to 5D are diagrams showing an example of evaluation processing of the inspection system according to the first embodiment;

FIGS. 6A and 6B are flowcharts showing the flow of the inspection processing of the inspection system according to the first embodiment;

FIG. 7 is a flowchart showing the flow of the inspection processing of the inspection terminal device according to a second embodiment;

FIGS. 8A and 8B are diagrams showing another example of imaging guides displayed in the displayer according to certain embodiments;

FIGS. 9A and 9B are diagrams showing examples of feature extractions of inspection images according to a modification 1;

FIGS. 10A to 10C are diagrams showing an example of the evaluation processing according to the modification 1;

FIGS. 11A to 11C are diagrams showing an example of the evaluation processing according to a modification 2;

FIGS. 12A to 12C are diagrams showing an example of the evaluation processing according to a modification 3; and

FIG. 13 is a schematic view illustrating a hardware configuration of the inspection device according to the first embodiment.

### DETAILED DESCRIPTION

An inspection terminal device according to an embodiment includes an imager, a displayer, a feature extractor, and an evaluator. The imager images an inspection object. The displayer displays an image of the inspection object imaged by the imager. The feature extractor extracts a feature of the inspection object in the image. The evaluator evaluates the inspection object based on the feature. The displayer displays an evaluation result of the evaluator to correspond to a position of the inspection object in the image.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions. In the specification and drawings, components similar to those described previously or illustrated in an antecedent drawing are marked with like reference numerals, and a detailed description is omitted as appropriate.

### First Embodiment

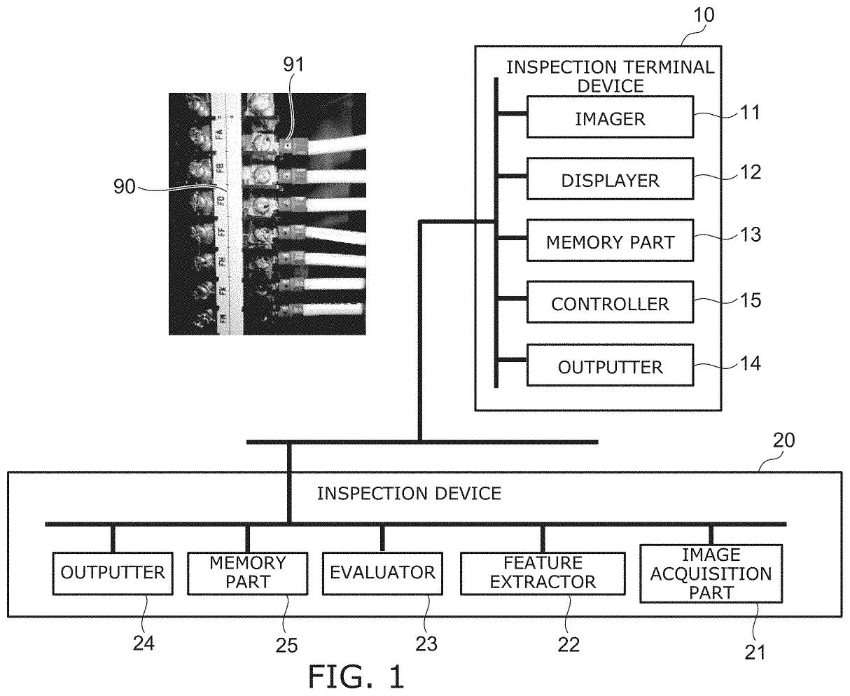

FIG. 1 is a schematic view illustrating a configuration of an inspection system according to a first embodiment.

The inspection system 1 includes an inspection terminal device 10, and an inspection device 20 that has a wired or wireless connection with the inspection terminal device 10. The inspection device 20 may be connected to the inspection terminal device 10 via a network.

In the inspection system 1, an image of an inspection object that is imaged by the inspection terminal device 10 is inspected (evaluated) by the inspection device 20; and the result of the inspection is output to the inspection terminal device 10.

An example is described in the embodiment in which many crimping terminals that are connected to a distribution board are used as the inspection object of the inspection system 1; and the connection state of the many crimping terminals is inspected.

The inspection terminal device 10 includes an imager 11, a displayer 12, a memory part 13, an outputter 14, and a controller 15 that controls these components. For example, a so-called smart device such as a smartphone, a tablet terminal device, etc., can be used as the inspection terminal device.

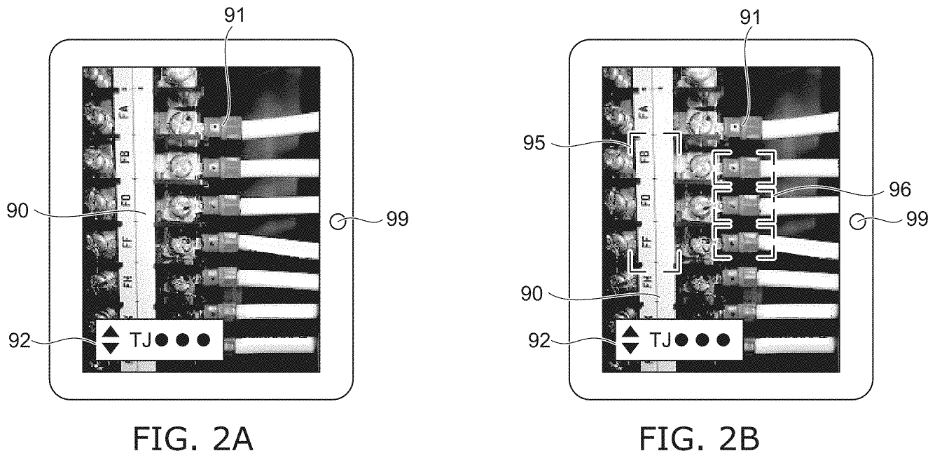

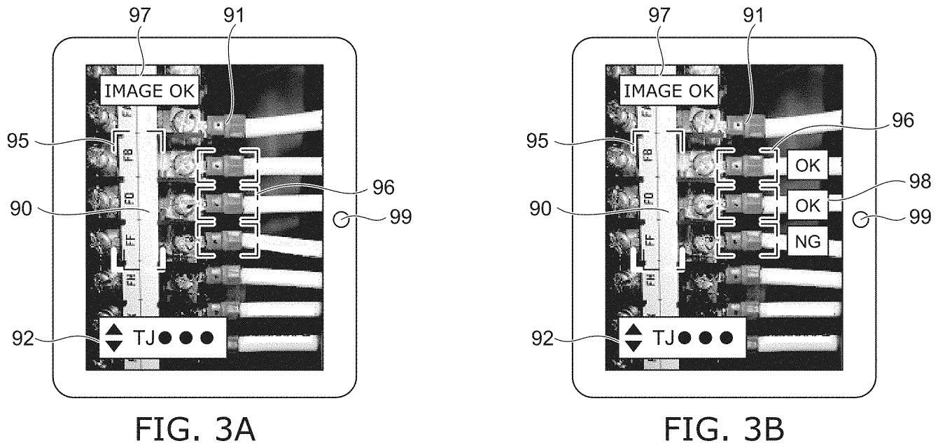

FIGS. 2A to 3B show an example of a display screen of the displayer of the inspection terminal device according to the embodiment.

The imager 11 images the inspection object. As shown in FIG. 2A, the imager 11 images multiple crimping terminals 91 that are connected to a terminal block 90. At this time, as shown in FIG. 2B, the imager 11 images in a state in which imaging guides 95 and 96, which are described below, are displayed in the displayer 12; and the positions of the terminal block 90 and the crimping terminals 91 are aligned with the imaging guides 95 and 96. Hereinbelow, the image of the inspection object that is imaged by the imager 11 is called the “inspection image”.

When the imaging by the imager 11 is performed, the displayer 12 displays the inspection object before imaging. The displayer 12 can display an imaging guide corresponding to the inspection object before the imaging by the imager 11. For example, the displayer 12 may be a touch panel and may also function as an input device.

As shown in FIG. 2A, for example, the displayer 12 displays a terminal block selection field 92. The desired terminal block can be selected from the multiple terminal blocks in the terminal block selection field 92. When the terminal block is selected, the imaging guides 95 and 96 that correspond to the selected terminal block 90 are read from the memory part 13 or a memory part 25 and are displayed in the displayer 12 as shown in FIG. 2B.

As shown in FIGS. 3A and 3B, for example, the displayer 12 displays an imaging state display field 97 that indicates the state of the inspection image. The imaging state display field 97 displays one of “image OK” or “image NG”. “Image OK” means that the inspection image can be used in the inspection of the inspection device 20, which is described below. “Image NG” means that the image is inappropriate for use in the inspection.

As shown in FIG. 3B, the displayer 12 displays the result of the inspection or the evaluation by the inspection device 20 (hereinbelow, called the “evaluation result”) in an evaluation result display field 98. The displayer 12 displays the evaluation result in the inspection image to correspond to the inspection object. In the example of FIG. 3B, the evaluation result display field 98 is provided next to the imaging guide 96 of the crimping terminals 91. In the example of FIG. 3B, the evaluation result display field 98 displays “OK” when the connection state of the crimping terminals is appropriate and “NG” when the connection state of the crimping terminals is inappropriate in the evaluation result. Here, an inappropriate connection state is considered to be a state in which the electrical wire is not crimped by the crimping terminal, the electrical connection between the crimping terminal and the electrical wire is insufficient, etc.

The memory part 13 stores the inspection image. For example, as imaging guides that correspond to the inspection object, the imaging guide 95 of the terminal block 90 to which the crimping terminals 91 are connected and the imaging guide 96 that indicates the connection positions of the crimping terminals 91 at the terminal block 90 are associated and stored beforehand in the memory part 13.

The outputter 14 outputs the inspection image to the inspection device 20.

The controller 15 controls the operations of the components of the inspection terminal device 10 described above. For example, when the terminal block is selected in the displayer 12, the controller 15 reads the imaging guide 95 of the selected terminal block 90 and the imaging guide 96 of the crimping terminals 91 corresponding to the terminal block 90 from a memory part 103 and displays these imaging guides.

When imaging, the displayer 12 displays the crimping terminals 91 before imaging with the imaging guides 95 and 96. When an imaging button 99 shown in FIGS. 2A and 2B or FIGS. 3A and 3B is pressed, the imager 11 is controlled to image the image of the inspection object; and the image (the inspection image) is stored in the memory part 13 or 25. The controller 15 outputs the image to the inspection device 20. When the input of the evaluation result from the inspection device 20 is accepted, the evaluation result is displayed by the displayer 12.

The inspection device 20 includes an image acquisition part 21, a feature extractor 22, an evaluator 23, an outputter 24, and the memory part 25.

The image acquisition part 21 acquires the image (the inspection image) of the crimping terminals that are the inspection object from the inspection terminal device 10. Here, the image of the crimping terminals is imaged by the inspection terminal device 10 in a state in which the crimping terminals are aligned with the imaging guide. The image acquisition part 21 outputs the image to the feature extractor 22.

The feature extractor 22 extracts the feature of the inspection object in the inspection image. When multiple inspection objects are included in the inspection image, features are extracted respectively for the multiple inspection objects.

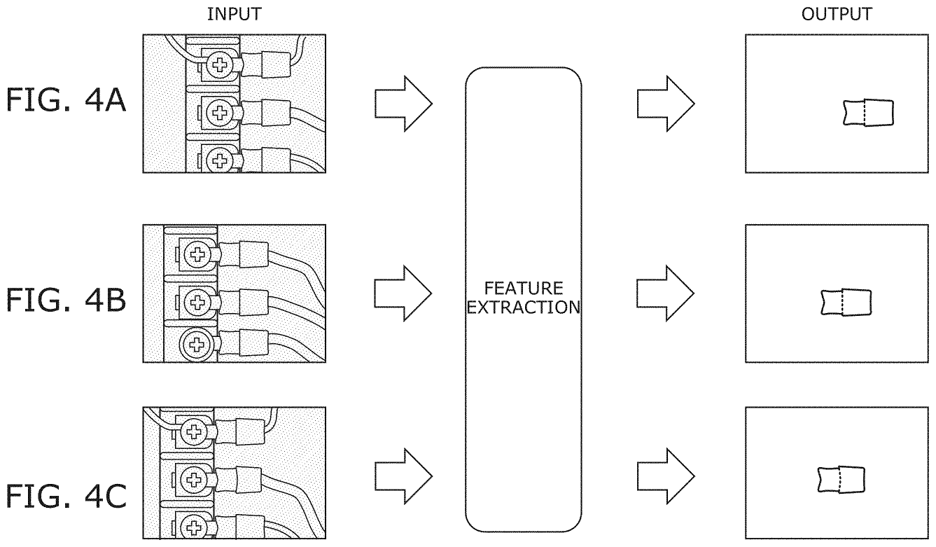

FIGS. 4A to 4C show examples of the feature extraction of the inspection device according to the inspection system according to the embodiment. As the feature, the feature extractor 22 according to the embodiment extracts the contour line of the crimping terminal and a boundary line that corresponds to the center of the connection portion between the crimping terminal and the electrical wire and generates an image that includes the contour line and the boundary line as a feature extraction image as shown in FIGS. 4A to 4C.

In the three examples shown in FIGS. 4A to 4C, the inspection images at the left side of FIGS. 4A to 4C are input to the feature extractor 22; and the images at the right side of FIGS. 4A to 4C are output as feature extraction images. Although multiple crimping terminals are included in the images of the examples of FIGS. 4A to 4C, the feature of the crimping terminal at the center of each of the images is extracted. The feature extractor 22 outputs the feature extraction image including the extracted feature to the evaluator 23.

Here, the extraction of the feature can be performed using a trained model.

For example, the trained model is generated utilizing a machine learning algorithm such as a neural network, etc. The trained model is generated by inputting training data set to the machine learning algorithm. The training data set include images of various connection states of the crimping terminals and labels indicating the contour lines and the boundary lines of the crimping terminals.

When the feature of the inspection object is extracted using such a trained model, the feature extractor 22 refers to the trained model described above. The feature extractor 22 inputs the inspection image according to the crimping terminal that is the inspection object to the trained model and extracts, as the feature, the contour line and the boundary line that are output from the trained model. The trained model can be prestored in the memory part 25, etc.

The evaluator 23 evaluates the appropriateness of the connection state of the crimping terminal based on the feature.

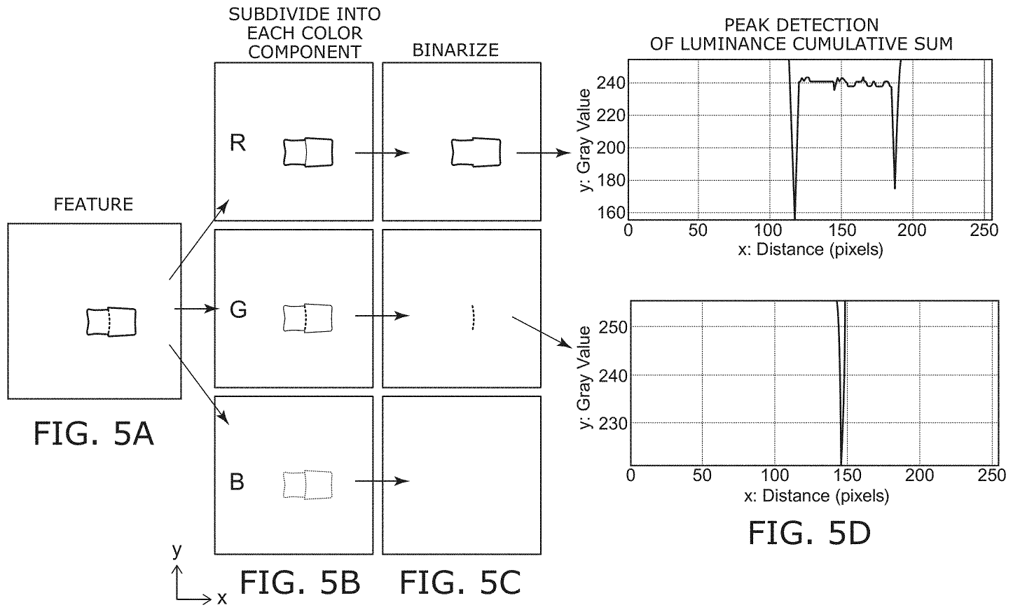

FIGS. 5A to 5D show an example of evaluation processing of the inspection system according to the embodiment.

As shown in FIGS. 5A to 5D, for example, the evaluator 23 generates an R image, a G image, and a B image by separating the feature extraction image including the contour line and the boundary line extracted by the feature extractor 22 into each color component. The evaluator 23 binarizes the R image, the G image, and the B image. The evaluator 23 calculates the luminance cumulative sum by summing the luminance values along each column of the y-axis in FIG. 5D for the R image, the G image, and the B image that are binarized.

The graphs in FIG. 5D illustrate the luminance cumulative sums along each column of the y-axis. The peaks of the luminance cumulative sums are detected from the calculated luminance cumulative sums for the R image, the G image, and the B image that are binarized. The y-axis direction in FIG. 5D is along the boundary line that corresponds to the central portion of the connection between the crimping terminal and the electrical wire of the crimped portion of the crimping terminal.

In the example of FIG. 5D, peaks are detected in the R image at two locations; and a peak is detected in the G image at one location. The evaluator 23 treats the peak values of these peaks as determination amounts for evaluating the appropriateness of the connection state of the crimping terminal. Specifically, the evaluator 23 evaluates whether or not Gc is a value within a prescribed range between RI and Rr, wherein the peak value at the left side of the R image in FIG. 5D is RI, the peak value at the right side of the R image in FIG. 5D is Rr, and Gc is the peak value of the G image.

For example, the evaluator 23 can evaluate the connection state of the crimping terminal to be appropriate when the following Formula (1) is satisfied.

Rw=Rl−Rr,

Gc>Rl+Rw/3, and

Gc<Rr+Rw/3 (1)

In the example of FIG. 5D, Rl=117, Rr=188, and Gc=146; therefore, Formula (1) described above is satisfied, and the connection state can be evaluated to be appropriate.

The evaluator 23 prepares the evaluation result as information that corresponds to the output destination and outputs the evaluation result to the outputter 24. According to the embodiment, the evaluation result is displayed by the displayer 12 of the inspection terminal device 10. Therefore, the evaluator 23 generates display information for displaying by the displayer 12 of the inspection terminal device 10 to correspond to the display positions of the crimping terminals in the inspection image. The display information is output via the outputter 24 as the evaluation result of the evaluator 23.

For example, the memory part 25 can store the trained model. The memory part 25 may store the inspection image acquired by the image acquisition part 21. The memory part 25 may store various images generated for the appropriateness evaluation of the evaluator 23. The memory part 25 may store formulas used in the evaluation processing of the evaluator 23, etc. Sets of the terminal block and the guides may be recorded.

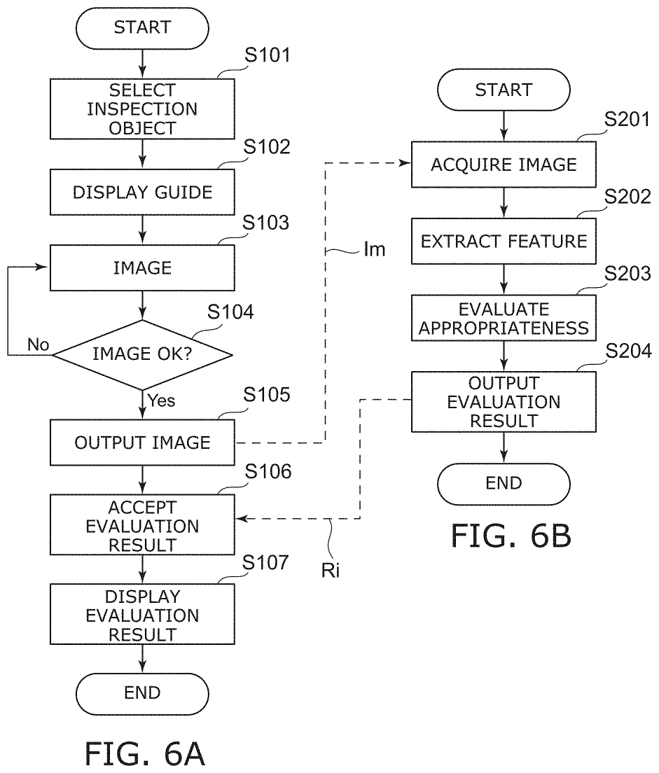

The flow of the inspection processing of an inspection system having such a configuration will now be described with reference to the flowchart of FIGS. 6A and 6B.

FIGS. 6A and 6B are flowcharts showing the flow of the inspection processing of the inspection system according to the embodiment. In the example, FIG. 6A shows the flow of the processing of the inspection terminal device 10; and FIG. 6B shows the flow of the processing of the inspection device 20.

In step S101, the user uses the inspection terminal device 10 to display the terminal block selection field 92 for imaging the crimping terminal that is the inspection object. The user selects, from the terminal block selection field 92, the model number of the terminal block 90 to be imaged (FIG. 2A).

In step S102, the imaging guides 95 and 96 are displayed by the displayer 12. Specifically, when the model number of the terminal block 90 is selected by the user, the imaging guide 95 of the terminal block 90 and the imaging guide 96 of the crimping terminals 91 that match the model number of the selected terminal block 90 are read by the controller 15 from the memory part 13 and displayed in the displayer 12 by the controller 15 (FIG. 2B).

In step S103, the imager 11 images the inspection object. Specifically, the user aligns the terminal block 90 and the crimping terminals 91 with the imaging guides 95 and 96 displayed in the displayer 12 of the inspection terminal device 10. When the imaging button 99 is pressed in a state in which the terminal block 90 and the crimping terminals 91 are aligned with the imaging guides 95 and 96, the imager 11 performs the imaging; and the inspection image is obtained.

In step S104, the controller 15 evaluates whether or not the inspection image that is imaged in step S103 will be appropriate when the inspection device 20 performs the inspection. For example, when the crimping terminals 91 are not aligned with the imaging guide 96 in the inspection image, etc., “image NG” is displayed in the imaging state display field 97; and the user is prompted to reimage. Step S104 is repeated until an inspection image that is suited to the inspection is imaged. When the inspection image is “image OK”, the flow proceeds to the next step S105 (FIG. 3A).

In step S105, the inspection image is output from the outputter 14 to the inspection device 20 (broken line Im of FIGS. 6A and 6B). The inspection terminal device 10 waits for the evaluation result from the inspection device 20.

In step S201, the inspection device 20 acquires the inspection image from the inspection terminal device 10.

In step S202, the feature extractor 22 inputs the inspection image acquired in step S201 to the trained model and extracts, as the feature of the inspection image, the contour line of the crimping terminal and the boundary line at the central portion of the connection between the crimping terminal and the electrical wire that are output from the trained model.

In step S203, the evaluator 23 evaluates the appropriateness of the connection state of the crimping terminal by using the feature extracted by the feature extractor 22 in step S202.

In step S204, the evaluator 23 outputs, to the inspection terminal device 10 via the outputter 24, the evaluation result of the evaluation described above as display information for displaying the evaluation result in the displayer 12 of the inspection terminal device 10 (broken line Ri of FIGS. 6A and 6B).

The processing transitions to the inspection terminal device 10 when the display information is output as the evaluation result from the inspection device 20 to the inspection terminal device 10.

In step S106, the inspection terminal device 10 accepts the display information of the evaluation result from the inspection device 20. In the inspection terminal device 10, based on the display information, the displayer 12 displays the inspection image having undergone the appropriateness evaluation and the evaluation result that is displayed to correspond to the crimping terminals of the inspection image (FIG. 3B).

Thus, according to the inspection system according to the embodiment, the inspection image is acquired by the inspection terminal device by imaging the crimping terminals that are the inspection object; and the inspection device performs the appropriateness evaluation of the crimping terminals based on the features of the inspection image. The appropriateness evaluation of the inspection object can be automatically performed thereby.

There are cases where it is difficult to acquire a stable inspection image due to the mounting location and/or the imaging environment of the inspection object; and there are cases where the position and/or the orientation of the inspection object in the image, the brightness of the image, etc., are uneven. According to the embodiment, the extraction of the feature of the inspection object is performed using a trained model. Thereby, the feature can be extracted with high accuracy. A robust appropriateness evaluation can be performed thereby.

### Second Embodiment

An inspection system in which the inspection terminal device 10 is connected to the inspection device 20 is described in the first embodiment described above. In the second embodiment, an example is described in which the imaging of the inspection object, the appropriateness evaluation, and the output (the display) of the evaluation result are performed by the inspection terminal device 10.

When the inspection terminal device 10 performs the appropriateness evaluation processing, for example, a trained model is prestored in the memory part 13. The controller 15 can operate as the feature extractor 22 and the evaluator 23 and can perform the extraction processing of the feature of the image and the appropriateness evaluation processing.

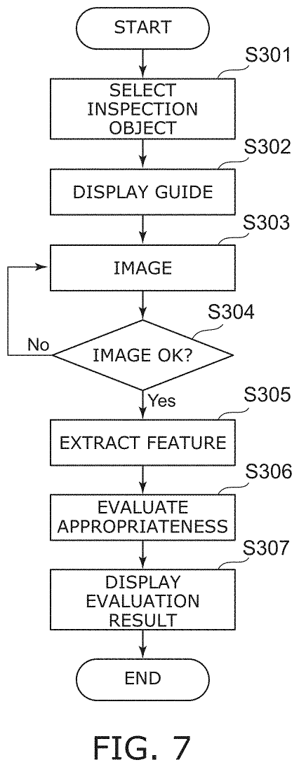

FIG. 7 is a flowchart showing the flow of the inspection processing of the inspection terminal device according to the second embodiment.

In step S301, the inspection object is selected in the inspection terminal device 10. Specifically, the displayer 12 displays the terminal block selection field 92; and the user selects the model number of the terminal block 90 to be imaged (FIG. 2A).

In step S302, the displayer 12 displays the imaging guides 95 and 96. Specifically, the displayer 12 displays the imaging guide 95 of the terminal block 90 and the imaging guide 96 of the crimping terminals 91 corresponding to the model number of the selected terminal block 90 when the model number of the terminal block 90 is selected (FIG. 2B).

In step S303, the inspection object is imaged and the inspection image is acquired. Specifically, the user aligns the terminal block 90 and the crimping terminals 91 with the imaging guides 95 and 96 displayed in the displayer 12 of the inspection terminal device 10. When the imaging button 99 is pressed in a state in which the terminal block 90 and the crimping terminals 91 are aligned with the imaging guides 95 and 96, the imager 11 is imaged, and the inspection image is obtained.

In step S304, the controller 15 evaluates whether or not the inspection image that is imaged in step S303 will be appropriate when the inspection device 20 performs the inspection. Step S304 is repeated until an inspection image that is suited to the inspection is imaged. When the inspection image is “image OK”, the flow proceeds to the next step S305 (FIG. 3A).

In step S305, in the controller 15, the inspection image that is imaged in step S303 is input to the trained model; and the contour line of the crimping terminal and the boundary line at the central portion of the connection between the crimping terminal and the electrical wire that are output from the trained model are extracted as the features of the inspection image.

In step S306, the appropriateness of the connection state of the crimping terminal is evaluated using the features extracted by the controller 15 in step S305.

In step S307, the controller 15 causes the displayer 12 to display the evaluation result. At this time, the displayer 12 displays the evaluation result with the inspection image so that the evaluation result corresponds to the crimping terminals of the inspection image (FIG. 3B).

Thus, according to the inspection terminal device according to the embodiment, the inspection image is acquired by imaging the crimping terminal that is the inspection object; and the appropriateness evaluation of the crimping terminal is performed based on the feature of the inspection image. The appropriateness evaluation of the inspection object can be automatically performed thereby. All of the processes from the imaging of the inspection image to the display of the evaluation result are performed by the inspection terminal device; therefore, it is unnecessary to consider the connection between the inspection terminal device and the inspection device, etc.; and the convenience when inspecting is improved.

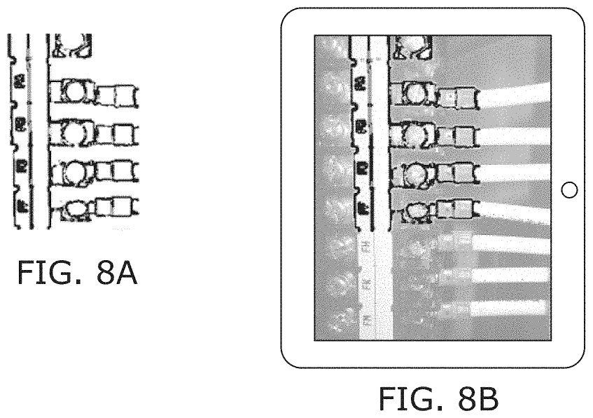

FIGS. 8A and 8B show another example of the imaging guide displayed in the displayer according to certain embodiments. Although the imaging guides 95 and 96 in FIGS. 2B, 3A, and 3B are the four corners of a rectangle according to the first and second embodiments described above, the imaging guide is not limited to such an example. For example, a figure that is generated by CAD may be used as the imaging guide as shown in FIG. 8A. FIG. 8B shows an example in which the inspection image that is displayed in the displayer 12 is imaged when the inspection object is aligned with an imaging guide generated by CAD.

### Modification 1

An example is described in the first and second embodiments described above in which a crimping terminal is the inspection object. An example is described in the modification in which the temperature sensor is the inspection object; and the insertion state of the temperature sensor into a socket or the connection state of the temperature sensor and the socket is inspected.

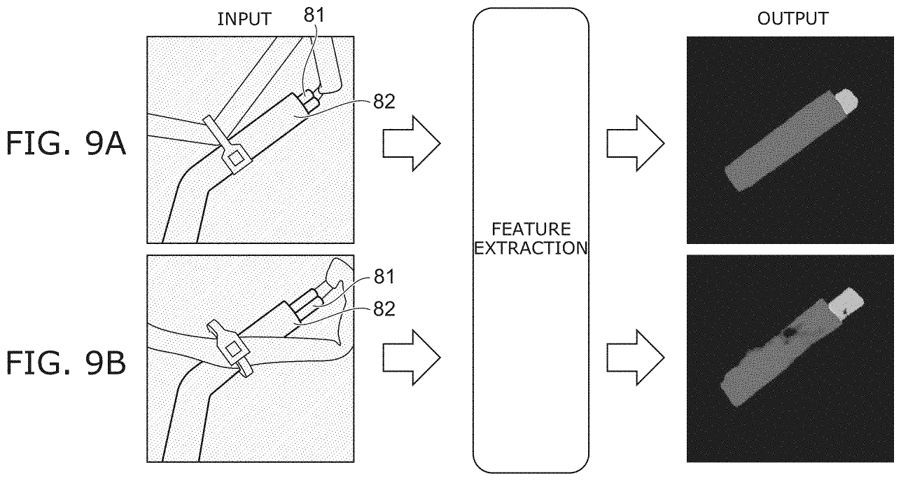

FIGS. 9A and 9B show examples of feature extractions of inspection images according to the modification 1.

In the two examples shown in FIGS. 9A and 9B, the inspection images at the left side of FIGS. 9A and 9B are input to the feature extractor 22; and the images at the right side of FIGS. 9A and 9B are output as feature extraction images. The feature extraction images of the examples of FIGS. 9A and 9B are images in which a temperature sensor 81 and a socket 82 are extracted from the inspection image. In the modification as well, by performing the extraction of the feature by using a trained model, the feature can be extracted with high accuracy even when the image quality of the inspection image is not stable.

Based on such feature extraction images, the evaluator 23 evaluates the connection state between the temperature sensor and the socket.

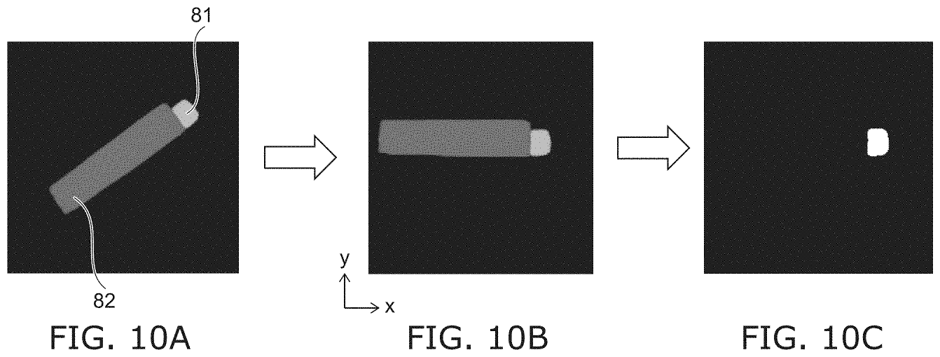

FIGS. 10A to 10C show an example of the evaluation processing according to the modification 1.

As shown in FIGS. 10A to 10C, for example, the evaluator 23 accepts the input of the feature extraction image in which the temperature sensor 81 and the socket 82 are extracted by the feature extractor 22 (FIG. 10A). Then, the evaluator 23 uses the socket as a reference to rotate the feature extraction image so that the longitudinal directions of the socket and the temperature sensor are along the x-axis in FIG. 10B (FIG. 10B).

Then, an image in which only the temperature sensor 81 portion is extracted is generated by binarizing the image (FIG. 10C). The area of the temperature sensor 81 portion in the image is calculated, and it is evaluated whether or not the area is greater than a predetermined threshold. When the area of the temperature sensor 81 is greater than the threshold, the evaluator 23 evaluates the insertion state of the temperature sensor 81 into the socket 82 or the connection state of the temperature sensor and the socket to be inappropriate. When the area of the temperature sensor 81 is not more than the threshold, the evaluator 23 evaluates the insertion state of the temperature sensor 81 into the socket 82 or the connection state of the temperature sensor and the socket to be appropriate.

### Modification 2

According to a modification 2, similarly to the modification 1 described above, the insertion state of the temperature sensor into the socket or the connection state of the temperature sensor and the socket is inspected. According to the modification, the processing of the evaluator 23 that is performed after the feature extractor 22 generates the feature extraction image in which the temperature sensor 81 and the socket 82 are extracted from the inspection image is different from that of the modification 1.

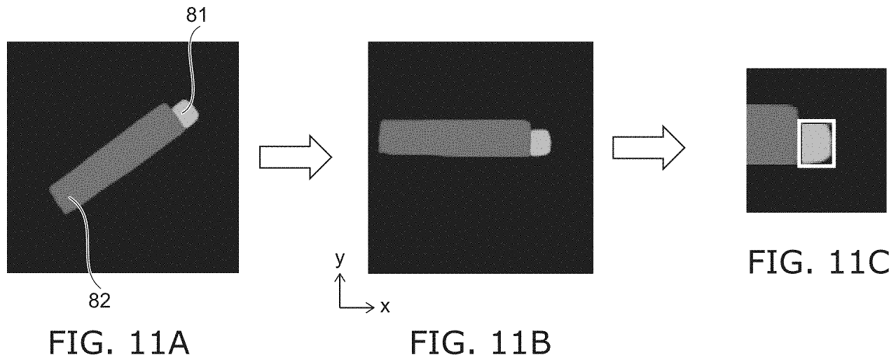

FIGS. 11A to 11C show an example of evaluation processing according to the modification 2.

As shown in FIGS. 11A to 11C, for example, the evaluator 23 accepts the input of the feature extraction image in which the temperature sensor 81 and the socket 82 are extracted by the feature extractor 22 (FIG. 11A). Then, the evaluator 23 uses the socket as a reference to rotate the feature extraction image so that the longitudinal directions of the socket and the temperature sensor are along the x-axis in FIG. 10B (FIG. 11B).

Then, the circumscribing rectangle of the temperature sensor 81 portion is calculated from the contour line of the image (FIG. 11C). The length of the x-axis direction side (hereinbelow, called the “x-side”) of the determined circumscribing rectangle is calculated, and it is evaluated whether or not the length of the x-side is greater than a predetermined threshold. When the length of the x-side of the temperature sensor 81 is greater than the threshold, the evaluator 23 evaluates the insertion state of the temperature sensor 81 into the socket 82 or the connection state of the temperature sensor and the socket to be inappropriate. When the length of the x-side of the temperature sensor 81 is not more than the threshold, the evaluator 23 evaluates the insertion state of the temperature sensor 81 into the socket 82 or the connection state of the temperature sensor and the socket to be appropriate.

### Modification 3

According to a modification 3, similarly to the modifications 1 and 2 described above, the insertion state of the temperature sensor into the socket or the connection state of the temperature sensor and the socket is inspected. According to the modification, the processing of the evaluator 23 that is performed after the feature extractor 22 generates the feature extraction image in which the temperature sensor 81 and the socket 82 are extracted from the inspection image is different from those of the modifications 1 and 2.

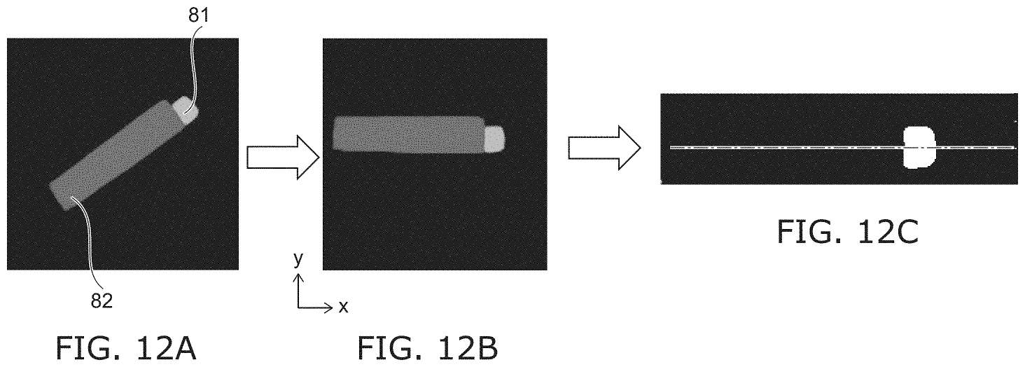

FIGS. 12A to 12C show an example of evaluation processing according to the modification 3.

As shown in FIGS. 12A to 12C, for example, the evaluator 23 accepts the input of the feature extraction image in which the temperature sensor 81 and the socket 82 are extracted by the feature extractor 22 (FIG. 12A). Then, the evaluator 23 uses the socket as a reference to rotate the feature extraction image so that the longitudinal directions of the socket and the temperature sensor are along the x-axis in FIG. 10B (FIG. 12B).

Then, an image in which only the temperature sensor 81 portion is extracted is generated by binarizing the image (FIG. 12C). The length in the x-axis direction at the y-axis direction center of the temperature sensor 81 portion in the image (hereinbelow, called simply the “length in the x-axis direction”) is calculated. The evaluator 23 evaluates whether or not the length in the x-axis direction is greater than a predetermined threshold.

When the length in the x-axis direction of the temperature sensor 81 is greater than the threshold, the evaluator 23 evaluates the insertion state of the temperature sensor 81 into the socket 82 or the connection state of the temperature sensor and the socket to be inappropriate. When the length in the x-axis direction of the temperature sensor 81 is not more than the threshold, the evaluator 23 evaluates the insertion state of the temperature sensor 81 into the socket 82 to be appropriate.

The evaluation is not limited to the length in the x-axis direction at the y-axis direction center; the circumscribing rectangle of the temperature sensor 81 may be calculated; the length along the x-axis direction of the circumscribing rectangle at each row may be calculated; and the insertion state of the temperature sensor 81 into the socket 82 or the connection state of the temperature sensor and the socket may be evaluated by comparing the maximum length and a threshold.

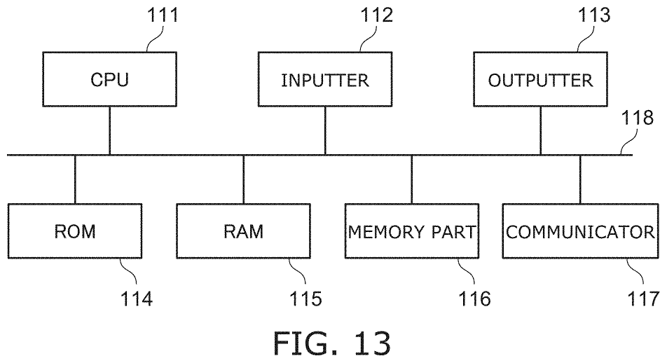

FIG. 13 is a schematic view illustrating a hardware configuration of the inspection device according to the first embodiment described above.

A general-purpose or dedicated computer is applicable as the inspection device described above. As shown in FIG. 13, the inspection device 20 includes a central processing unit (CPU) 111, an inputter 112, an outputter 113, ROM (Read Only Memory) 114, RAM (Random Access Memory) 115, a memory part 116, a communicator 117, and a bus 118. The components are connected by the bus 118.

The CPU 111 executes various processing in collaboration with various programs prestored in the ROM 114 or the memory part 116 and comprehensively controls the operations of the inspection device 20. The function as the image acquisition part 21, the feature extractor 22, and the evaluator 23 of the inspection device described above is realized thereby. In the processing, the CPU 111 uses a prescribed region of the RAM 115 as a work region. The CPU 111 realizes the inputter 112, the outputter 113, the communicator 117, etc., in collaboration with programs prestored in the ROM 114 or the memory part 116.

The inputter 112 includes, for example, a keyboard, a mouse, or a touch panel. The inputter 112 accepts information input from the user as instruction signals and outputs the instruction signals to the CPU 111. The outputter 113 is, for example, a monitor. The outputter 113 visibly outputs various information based on signals output from the CPU 111.

The ROM 114 non-rewritably stores programs used to control the inspection device 20, various setting information, etc. The RAM 115 is a volatile storage medium such as SDRAM (Synchronous Dynamic Random Access Memory), etc. The RAM 115 functions as a work region of the CPU 111. Specifically, the RAM 115 functions as the memory part 25 described above. That is, the RAM 115 functions as a buffer temporarily storing inspection images that are used by the inspection device 20 as the inspection object, extracted features, etc.

The memory part 116 is a rewritable recording device such as a semiconductor storage medium such as flash memory or the like, a magnetically or optically recordable storage medium, etc. The memory part 116 stores programs used to control the inspection device 20, various setting information, trained models, etc. For example, the communicator 117 is used to transmit and receive information by communicating with external devices such as the inspection terminal device 10, etc.

According to the embodiments described above, the appropriateness evaluation of an inspection object can be automatically performed with high accuracy.

Hereinabove, embodiments of the invention are described with reference to specific examples. However, the invention is not limited to these specific examples. For example, one skilled in the art may similarly practice the invention by appropriately selecting specific configurations of components included in the inspection terminal device, the inspection device, and the inspection system from known art; such practice is within the scope of the invention to the extent that similar effects can be obtained.

Combinations of any two or more components of the specific examples within the extent of technical feasibility also is within the scope of the invention to the extent that the spirit of the invention is included.

Also, all inspection terminal devices, the inspection devices, and the inspection systems practicable by an appropriate design modification by one skilled in the art based on the inspection terminal devices, the inspection devices, and the inspection systems described above as embodiments of the invention also are within the scope of the invention to the extent that the spirit of the invention is included.

Furthermore, various modifications and alterations within the spirit of the invention will be readily apparent to those skilled in the art; and all such modifications and alterations also should be seen as being within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An inspection terminal device, comprising:
an imager imaging an inspection object;
a displayer displaying an image of the inspection object imaged by the imager;
a feature extractor extracting a feature of the inspection object in the image; and
an evaluator evaluating the inspection object based on the feature,
the displayer displaying an evaluation result of the evaluator to correspond to a position of the inspection object in the image.

2. The inspection terminal device according to claim 1, wherein
the displayer displays, before the imaging of the inspection object by the imager, an imaging guide that corresponds to the inspection object and indicates an imaging position of the inspection object.

3. The inspection terminal device according to claim 1, wherein
the feature extractor extracts the feature by using a trained model.

4. The inspection terminal device according to claim 1, wherein
the feature extractor extracts, as the feature, at least one of a contour line or a boundary line of the inspection object from the image.

5. The inspection terminal device according to claim 1, wherein
the evaluator calculates a luminance cumulative sum in one axis direction of the at least one of the contour line or the boundary line and evaluates the inspection object based on the luminance cumulative sum.

6. The inspection terminal device according to claim 1, wherein
the inspection terminal device is a portable terminal device including a tablet terminal device or a smartphone.

7. An inspection device, comprising:
an inputter accepting an input of an image of an inspection object;
a feature extractor extracting a feature of the inspection object in the image;
an evaluator evaluating the inspection object based on the feature; and
an outputter outputting an evaluation result of the evaluator as display information for displaying the evaluation result to correspond to a display position of the inspection object in the image.

8. The inspection device according to claim 7, wherein
the feature is extracted from the image by using a trained model.

9. The inspection device according to claim 7, wherein
the image is imaged in a state in which a position of the inspection object is aligned with an imaging guide corresponding to the inspection object.

10. An inspection system, comprising:
an inspection terminal device; and
an inspection device communicatably connected with the inspection terminal device,
the inspection terminal device including
an imager imaging an inspection object, and
a displayer displaying an image imaged by the imager,
the inspection device including
an inputter accepting an input of the image from the inspection terminal device,
a feature extractor extracting a feature of the inspection object in the image,
an evaluator evaluating the inspection object based on the feature, and
an outputter outputting, to the inspection terminal device, an evaluation result of the evaluator as display information for displaying, in the displayer, the evaluation result to correspond to a position of the inspection object in the image.

11. The inspection system according to claim 10, wherein
the feature extractor extracts the feature by using a trained model.

12. The inspection system according to claim 10, wherein
the displayer displays, before the imaging of the inspection object by the imager, an imaging guide that corresponds to the inspection object and indicates an imaging position of the inspection object.

13. An inspection program causing a computer to execute processing, the processing comprising:
acquiring an image of an inspection object;
extracting at least one of a contour line or a boundary line of the inspection object as a feature of the image by using a trained model;
calculating numerical data evaluating an object from the feature, and evaluating the inspection object based on the numerical data; and
displaying the evaluation result to correspond to a position of the inspection object in the image.

14. The inspection program according to claim 13 causing a computer to execute processing, the processing comprising:
displaying the evaluation result to correspond to a position of the inspection object in the image.

15. The inspection program according to claim 13, wherein
the image is imaged in a state in which a position of the inspection object is aligned with an imaging guide corresponding to the inspection object.
